(19) United States
(12) Patent Application Publication
(10) Pub. No.: US 2005/0086657 A1
(43) Pub. Date: Apr. 21, 2005

(54) Service scheduling

(75) Inventors: James L. Jason JR., Hillsboro, OR (US); Erik J. Johnson, Portland, OR (US); Harrick M. Vin, Austin, TX (US); Jayaram Mudigonda, Austin, TX (US)

Correspondence Address: FISH & RICHARDSON, PC, 12390 EL CAMINO REAL, SAN DIEGO, CA, 92130-2081, US

(73) Assignee: Intel Corporation

(21) Appl. No.: 10/691,116

(22) Filed: Oct. 21, 2003

(51) Int. Cl. G06F 9/46

(52) U.S. Cl. 718/102

(57) ABSTRACT

A process, method, and system that examines a set of services to identify two or more parallel services performed by a common processor. A defined number of data elements are processed to simulate a data flow through the set of services. An element ratio is determined that defines the portion of data elements processed by each of the parallel services.

### BACKGROUND

Packet-processing services with different levels of complexity are often mapped onto the same processor core in order to balance loads across multiple processor cores in a network processor. Although this load balancing technique provides better load balancing, it often increases the possibility of performance degradation. For instance, a burst arrival of packets requesting one type of service can adversely impact processing of packets requesting other services provided by the same processor core.

To ensure that the processing requirements of packets invoking different services are met, processors often use dynamic scheduling algorithms to dynamically allocate the resources of a processor to the various services being performed by that processor. Unfortunately, the overhead required to execute these dynamic scheduling algorithms further loads the processor whose bandwidth is being allocated.

### DESCRIPTION OF DRAWINGS

FIG. 1 is a block diagram of a network system incorporating a network processor;

FIG. 2 is a data flow graph of a set of services performed by the network processor of FIG. 1;

FIG. 3 is a block diagram of a compiler program including a service scheduler;

FIG. 4 is a block diagram of an examination module and a simulation module of the service scheduler of FIG. 3;

FIG. 5 is a block diagram of a parameter definition module and a scheduler generation module of the service scheduler of FIG. 3; and

FIG. 6 is a data flow graph including a scheduler and a pair of queues.

### DETAILED DESCRIPTION

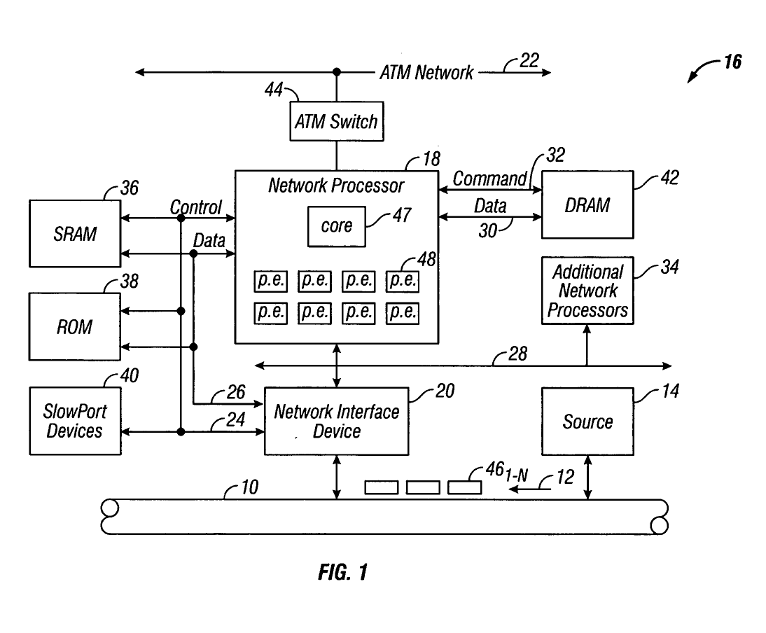

Referring to FIG. 1, a network 10 transfers data 12 from a source 14 to a network processing system 16. Network 10 can use any medium (e.g. electrical, optical, and wireless) and be of any type (e.g., a local area network, a wide area network, an intranet, an extranet, the Internet, Ethernet, Arcnet, Token Ring, packet-switched, circuit-switched, and so forth). Source 14 and network processing system 16 may be incorporated into any device on a network, such as a printer, a personal computer, a router, a gateway, a network server, a network interface card, a cable modem, or any other media access control (MAC) addressable device.

Network processing system 16 includes a network processor 18 for processing data 12 retrieved or transmitted by a network interface device 20. A typical example of network processor 18 is an Intel IXP1200 Network Processor, and network interface device 20 may be any MAC addressable device.

Network interface device 20 typically includes the required circuitry to convert data signal 12 from the format available on network 10 into a format useable by network processor 18. For example, if network 10 is an optical network, network interface device 20 is typically configured so that it can receive an optical signal and convert that optical signal to an electrical-based signal useable by network processor 18.

Network processor 18 typically interfaces with various other networks, and buses (e.g., network 22, and buses 24, 26, 28, 30, 32) to interconnect various devices and circuitry, such as additional network processors 34, static random access memory (SRAM) 36, read only memory (ROM) 38, SlowPort devices 40 (e.g flash memory, Universal Asynchronous Receiver/Transmitter (UART), and Universal Serial Bus (USB)), and dynamic random access memory (DRAM) 42.

If network 22 is an asynchronous transfer mode (ATM) network, network processor 18 is interconnected with ATM network 22 via ATM switch 44.

In packet-switching networks (as opposed to circuit-switching networks), data 12 is transported in the form of packets 46_{1-N} of various sizes. As packets 45_{1-N} are received by network interface device 20, individual data packets are temporarily stored until the packets can be processed by the network processor 18.

The Intel IXP1200 Network Processor includes a core X-scale RISC processor 47 and multiple Reduced Instruction Set Computer (RISC) multithreaded packet engines 48 (which are sometimes referred to as microengines or packet engines) that share resources, such as SRAM 36, ROM 38, SlowPort devices 40, and DRAM 42.

As the packet engines 48 are multi-threaded, they are capable of performing multiple tasks (e.g., services) simultaneously. These services may include, for example, saving a data packet to memory, retrieving a data packet from memory, encrypting a data packet, decrypting a data packet, encoding a data packet, decoding a data packet, segmenting a data packet into 53-byte ATM cells, and reassembling a data packet from multiple 53-byte ATM cells.

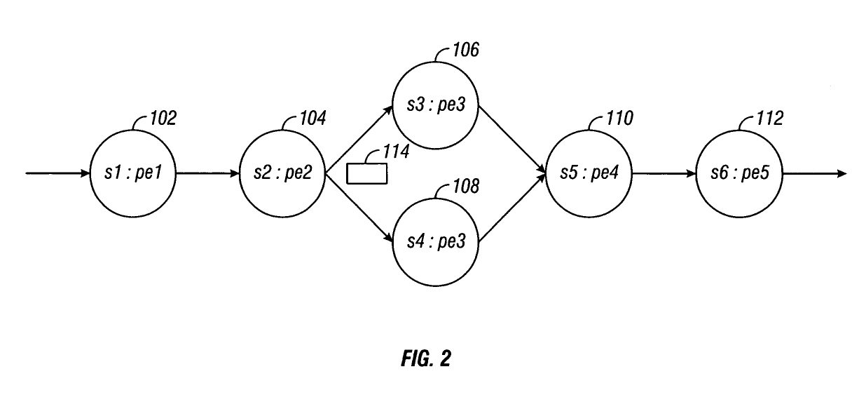

Referring to FIG. 2, when designing an application to be executed on a network processor 18, the services to be performed by the packet engines are typically represented in a data flow graph 100. These diagrams specify the services (e.g., services 102, 104, 106, 108, 110, and 112) to be performed. Each of these services is assigned to and performed by a specific one or more packet engines. For example, service s1 is performed by packet engine pe1, service s2 is performed by packet engine pe2, services s3 and s4 are performed by packet engine pe3, service s5 is performed by packet engine pe4, and service s6 is performed by packet engine pe5.

When processing data, a data packet (e.g., packet 114) is processed by either service s3 or s4. For example, assume that all packets received by service s5 need to be previously encrypted and compressed, and all packets leaving service s2 are not compressed but may (or may not) be encrypted. Service s3 may be configured to encrypt and compress a packet, whereas service s4 may be configured to only compress a packet.

Accordingly, if a packet 114 is not encrypted and not compressed, the packet 114 is sent to service s3 so that the data packet can be both encrypted and compressed. However, if the packet 114 is already encrypted but is not compressed, the packet 114 is sent to service s4 so that it can be compressed.

As explained above, each packet engine may perform multiple services. For example, services s3 and s4 are both executed by packet engine pe3. Thus, in the event that a particular service receives a burst transfer of packets that need to be processed, the other service(s) sharing that packet engine may be essentially stopped. For example, if services s3 and s4 typically receive packets in groups of two, packet engine pe3 would typically process two non-encrypted, non-compressed packets for service s3, and then switch control to service s4 so that two encrypted, non-compressed packets can be processed. Once service s4 completes this process, service s3 may again regain control of packet engine pe3 to process packets waiting to be processed.

However, if a group of, e.g., five-thousand non-encrypted, non-compressed packets is received and processed by service s2, these five-thousand packets would subsequently be sent to service s3 for processing. Service s3 would obtain control of packet engine pe3 and, typically, not relinquish control of packet engine pe3 until all five-thousand packets are processed (e.g., encrypted and compressed). Any packets received for service s4 (e.g., any encrypted, non-compressed packets) would be queued for processing until control of packet engine pe3 is handed over to service s4. That is, service s3 dominates packet engine pe3 until the processing of the five-thousand packets is complete.

Rules are established (e.g., at the time that a network processor is configured to handle an application) to minimize domination of a packet engine by a particular service. These rules specify the manner in which a packet engine is shared amongst multiple services.

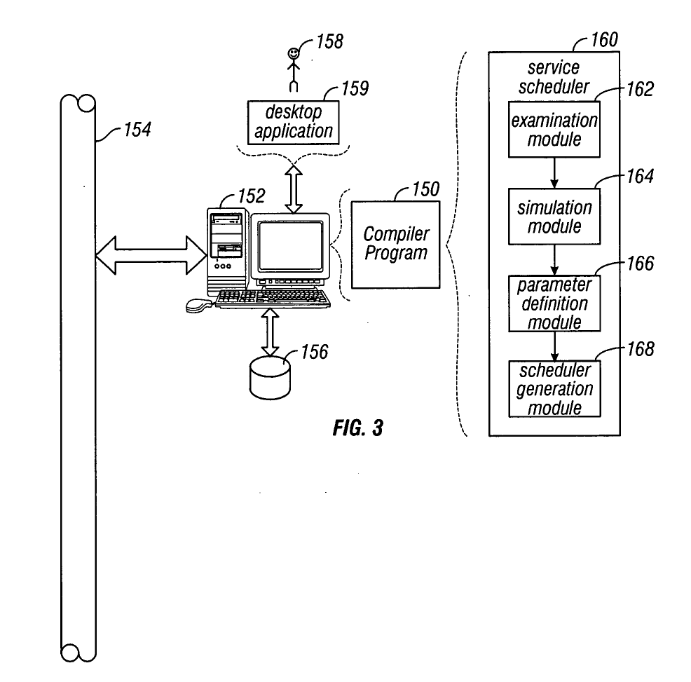

Referring to FIG. 3, when configuring a network processor, mapping information (not shown) including a description of the services performed by each packet engine of the network processor, and the interaction of the services, is entered into a compiler 150.

Compiler 150 resides on and is executed by a computer 152 that may be connected to a network 154 (e.g., the Internet, an intranet, a local area network, or some other form of network). The instruction sets and subroutines of compiler 150 are typically stored on a storage device 156 connected to computer 152.

Storage device 156 may be, for example, a hard disk drive, a tape drive, an optical drive, a RAID array, a random access memory (RAM), or a read-only memory (ROM). A programmer/user 158 typically accesses, administers, and uses compiler 150 through a desktop application 159 (e.g., a specialized compiler interface, a text editor, or a visual editor) running on computer 152 or another computer (not shown) that is also connected to network 154.

Compiler 150 includes a service scheduler 160 having an examination module 162, a simulation module 164, a parameter definition module 166, and a scheduler generation module 168, each of which will be discussed below in greater detail.

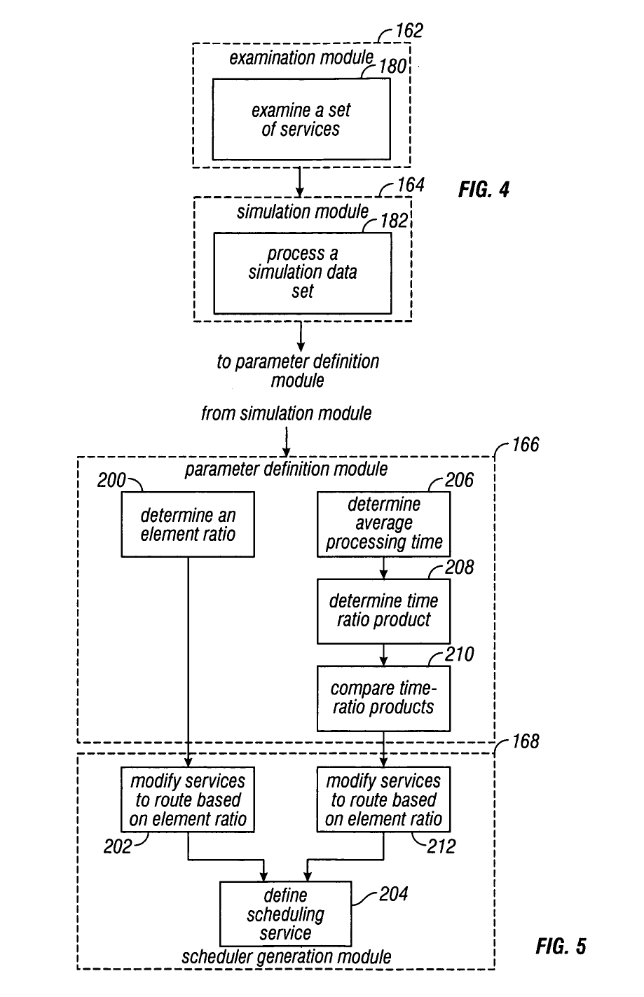

Referring to FIG. 4, the examination module 162 (FIG. 3) is configured to examine 180 the set of services to be implemented by a network processor. As stated above, when programming a network processor, the user 158 of compiler 150 provides mapping information concerning the services to be performed by each of the packet engines of the network processor. This mapping information is entered into compiler 150 as a data flow graph (e.g., the data flow graph of FIG. 2) or a series of text-based line items. An example of the text-based lines items may be as follows:

| | starting | ending | packet |
|---|---|---|---|
| service | point | point | engine |
| s1 | START | s2 | Pe1 |
| s2 | s1 | S3 or s4 | Pe2 |
| s3 | s2 | s5 | Pe3 |
| s4 | s2 | s5 | Pe3 |
| s5 | s3 or s4 | s6 | Pe4 |
| s6 | s5 | END | Pe5 |

Examination module 162 examines 180 the mapping information concerning the services to be performed by the network processor to determine if any set of services (e.g., two or more services) are performed by a common packet engine.

Referring also to the above table and FIG. 2, services s3 and s4 are parallel services that are performed by a common packet engine (namely packet engine pe3). As discussed above, since these two services are in parallel and performed by a common packet engine, either one of services s3 and s4 may dominate packet engine pe3. In order to reduce the effect of domination, rules are established to control the sharing of packet engine pe3.

Prior to establishing a rule set, simulation module 164 processes 182 a simulation data set (e.g., a defined number of representative data packets/elements) to simulate the flow and processing of data by the set of services defined by the mapping information entered into compiler 150. The simulation data set used by simulation module 164 should be typical of the type and distribution of data packets expected to be processed by the set of services.

Continuing with the above-stated example, in which non-encrypted, non-compressed, data packets are sent to service s3, and encrypted, non-compressed, data packets are sent to service s4, assume that the simulation data set includes 2,500 data packets, of which 1,500 are non-encrypted, non-compressed packets that are sent to service s3, and 1,000 are encrypted, non-compressed packets that are sent to service s4.

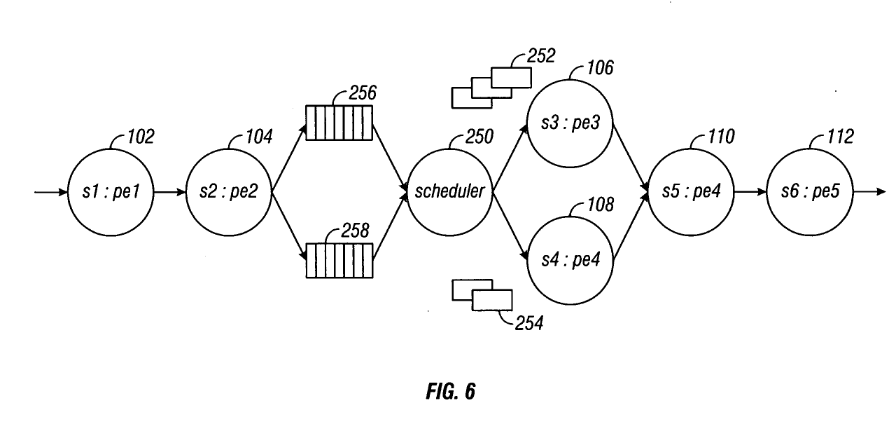

Referring to FIGS. 5 and 6, parameter definition module 166 determines 200 an element ratio based on the distribution of data packets between the parallel services (e.g., services s3 and s4). As 1,500 of the 2,500 packets were sent to service s3 and 1,000 of the 2,500 packets were sent to service s4, 60% of the data packets were sent to service s3 and 40% of the data packets were sent to service s4. Accordingly, the element ratio may be expressed in various formats, such a 60%:40%, 3:2, and 1,500:1,000, for example.

Once this element ratio is established, scheduler generation module 168 modifies 202 the set of services to route the data packets based on the element ratio. Typically, a scheduling service 250 is defined 204 that distributes the data packets between parallel services s3 and s4 in accordance with the element ratio defined above.

Since service s3 is expected to receive three data packets for each two data packets received by service s4, scheduling service 250 will distribute the data packets in accordance with the defined element ratio (or multiples thereof). In one example, scheduling service 250 is configured to route three packets 252 to service s3 and then route two packets 254 to service s4.

Alternatively, scheduling service 250 is configured to route packets in, for example, groups of ten in accordance with the element ratio defined above. Accordingly, the scheduling service would route thirty packets to service s3 and then twenty packets to service s4, and so forth.

A queue 256 and 258 is established and maintained for each service to allow for temporary storage of data packets received for a first service while packets are being sent to a second service. For example, if during the routing of three packets to service s3, a packet is received that needs to be sent to service s4, the packet is temporarily stored in the queue associated with service s4, namely queue 258. Once the routing of the third packet to service s3 is completed, the packet temporarily stored in queue 258 (e.g., the queue associated with service s4) is sent to service s4.

If, during this routing of packets to service s4, a packet is received for service s3, that packet is temporarily stored in the queue associated with service s3 (e.g., queue 256) until packets are again sent to service s3.

Queues 256 and 258 are typically FIFO (first-in-first-out) queues that are sized to provide ample storage for the number of data packets expected to be received during any delayed routing period.

The above-described distribution process is based on the percentage of packets distributed to each parallel service and does not take into account the amount of time required for each of the parallel services to process each packet. In situations where a first parallel service takes substantially longer to process a packet than a second parallel service takes to process a packet, it may be desirable to wholly or partially normalize the ratio in accordance with the time disparity.

As stated above, service s3 encrypts and compresses each packet received, while service s4 only compresses each packet received. Accordingly, it will probably take longer, on average, for service s3 to encrypt and compress a packet than it would for service s4 to compress a packet.

Continuing with the above-stated example, assume that it takes (on average) 300 nanoseconds for service s3 to encrypt and compress a packet, while it only takes (on average) 50 nanoseconds for service s4 to compress an already encrypted packet. If the packets are distributed based solely on the element ratio defined above (e.g., three packets to service s3 for each two packets for service s4), it would take 900 milliseconds for service s3 to process three packets, and only 100 milliseconds for service s4 to process two packets. Accordingly, 90% of the processing time of packet engine pe3 (e.g., the packet engine servicing services s3 and s4) is used by service s3 and only 10% of the processing time of packet engine pe3 is used by service s4.

If a more equitable time-based packet engine distribution is desired, parameter definition module 166 determines 206 an average packet processing time for each of the parallel services. This can be accomplished by providing a group of packets to a specific parallel process, determining the total time required to process the group of packets, and dividing the total time by the number of packets processed. As stated above, assume that parameter definition module 166 determines 206 that (on average) it takes 300 nanoseconds for service s3 to process a packet and 50 nanoseconds for service s4 to process a packet.

Once the individual average processing times are determined, parameter definition module 166 determines 208 a time-ratio product for each of the parallel services. This time-ratio product is the product of the element ratio and the average processing time for each of the parallel services. The specific units of the element ratio and the average processing time is not important, provided the units are consistent between parallel services. The time-ratio product for services s3 and s4 are as follows:

| | element | average | time-ratio |
|---|---|---|---|
| service | ratio | processing time | product |
| s3 | 3 | 300 ns. | 900 |
| s4 | 2 | 50 ns. | 100 |

As shown in the above table, it takes nine times a long for service s3 to process three packets than it does for service s4 to process two packets. Therefore, service s4 can process eighteen packets in 900 nanoseconds, the same amount of time that it takes service s3 to process just three packets.

Accordingly, time parity (e.g., equal packet engine time assigned to each service) can be achieved if eighteen packets are processed by service s4 for each three packets processed by service s3. However, since on average service s3 receives 50% more packets (e.g., 3 vs. 2) than service s4 for any given period of time, processing eighteen s4 packets for each three s3 packets may results in packet delays and a higher potential for dropped packets.

Accordingly, parameter definition module 166 compares 210 the time-ratio products for each of the parallel services to determine a normalized ratio. In this example, the normalized ratio is 9:1, in that applying the 3:2 element ratio results in service s3 monopolizing 90% of the processing time of packet engine pe3.

In light of this processing time disparity, scheduler generation module 168 may modify 212 the set of services to route the data packets based on the normalized ratio.

As discussed above, scheduling service 250 may distribute the data packets between parallel services s3 and s4 in accordance with the previously-defined element ratio (e.g., 3:2). In this implementation, three packets are processed by service s3 and two packets are processed by service s4, as service s3 receives three packets for each two packets received by service s4.

Alternatively, if true packet engine time parity is desired, scheduling service distributes the packets between parallel services s3 and s4 in accordance with the normalized ratio defined above (e.g., 1:9). In this implementation, three packets are processed by service s3 and eighteen packets are processed by service s4, as both of the operations take 900 nanoseconds.

Typically, the user of the service scheduler (see FIG. 3) configures scheduler 250 so that the packets are distributed at a rate somewhere between that which achieves “packet parity” (e.g., three packets processed by service s3 for each two packets processed by service s4) and “time parity” (e.g., three packets processed by service s3 for each eighteen packets processed by service s4).

For example, the user of the service scheduler may choose to configure scheduler 250 so that for every three s3 packets processed (e.g., a total of 900 ns. processing time), six s4 packets are processed (e.g., a total of 300 ns. processing time).

While the above-described example is shown to include two parallel services, other configurations are possible such as those that include three or four parallel services.

The described system is not limited to the implementations described above, as it may find applicability in any computing or processing environment. The system may be implemented in hardware, software, or a combination of the two. For example, the system may be implemented using circuitry, such as one or more of programmable logic (e.g., an ASIC), logic gates, a processor, and a memory.

The system may be implemented in computer programs executing on programmable computers, each of which includes a processor and a storage medium readable by the processor (including volatile and non-volatile memory and/or storage elements). Each such program may be implemented in a high-level procedural or object-oriented programming language to communicate with a computer system. However, the programs can be implemented in assembly or machine language. The language may be a compiled language or an interpreted language.

Each computer program may be stored on an article of manufacture, such as a storage medium (e.g., CD-ROM, hard disk, or magnetic diskette) or device (e.g., computer peripheral), that is readable by a general or special purpose programmable computer for configuring and operating the computer when the storage medium or device is read by the computer to perform the functions of the system.

The system may also be implemented as a machine-readable storage medium, configured with a computer program, where, upon execution, instructions in the computer program cause a machine to operate to perform the functions of the system described above.

Implementations of the system may be used in a variety of applications. Although the system is not limited in this respect, the system may be implemented with memory devices in microcontrollers, general purpose microprocessors, digital signal processors (DSPs), reduced instruction-set computing (RISC), and complex instruction-set computing (CISC), among other electronic components.

Implementations of the system may also use integrated circuit blocks referred to as main memory, cache memory, or other types of memory that store electronic instructions to be executed by a microprocessor or store data that may be used in arithmetic operations.

A number of implementations have been described. Nevertheless, it will be understood that various modifications may be made. Accordingly, other implementations are within the scope of the following claims.

1. A method comprising:
examining a set of services to identify two or more parallel services performed by a common processor;
processing a defined number of data elements to simulate a data flow through the set of services; and
determining an element ratio that defines the portion of data elements processed by each of the parallel services
defining a scheduling service that distributes the data elements to each parallel service.

2. The method of claim 1 further comprising:
modifying the set of services to route the data elements based on the element ratio.

3. The method of claim 2 wherein the common processor is a packet engine.

4. The method of claim 1 further comprising:
determining an average processing time for each of the parallel services, the average processing time representing the average time that a parallel service requires to process a single data element.

5. The method of claim 4 further comprising:
determining a time-ratio product for each of the parallel services, the time-ratio product being based on the mathematical product of the average processing time and the element ratio.

6. The method of claim 5 further comprising:
comparing the time-ratio products of each parallel process to determine a normalized ratio.

7. The method of claim 6 further comprising:
modifying the set of services to route the data elements based on the normalized ratio.

8. The method of claim 7 further comprising:
defining a scheduling service that distributes the data elements to each parallel service.

9. The method of claim 1 wherein the set of services is represented by a data flow graph.

10. The method of claim 1 wherein each data element is a data packet.

11. A computer program product residing on a computer readable medium having a plurality of instructions stored thereon which, when executed by the processor, cause that processor to:
examine a set of services to identify two or more parallel services performed by a common processor;
process a defined number of data elements to simulate a data flow through the set of services; and
determine an element ratio that defines the portion of data elements processed by each of the parallel services
define a scheduling service that distributes the data elements to each parallel service.

12. The computer program product of claim 11 further comprising instructions for:
modifying the set of services to route the data elements based on the element ratio.

13. The computer program product of claim 12 wherein the processor is a packet engine.

14. The computer program product of claim 11 further comprising instructions for:
determining an average processing time for each of the parallel services;
wherein the average processing time represents the average time that a parallel service requires to process a single data element.

15. The computer program product of claim 14 further comprising instructions for:
determining a time-ratio product for each of the parallel services;
wherein the time-ratio product is based on the mathematical product of the average processing time and the element ratio.

16. The computer program product of claim 15 further comprising instructions for:
comparing the time-ratio products of each parallel process to determine a normalized ratio.

17. The computer program product of claim 16 further comprising instructions for:
modifying the set of services to route the data elements based on the normalized ratio.

18. The computer program product of claim 17 further comprising instructions for:
defining a scheduling service that distributes the data elements to each parallel service.

19. The computer program product of claim 11 wherein the set of services is represented by a data flow graph.

20. The computer program product of claim 11 wherein each data element is a data packet.

21. A switch comprising:
a media access control (MAC) addressable device, comprising:
a network processor including:
a plurality of packet engines for processing packets;
a computer readable medium holding static configuration rules that specify the manner in which at least one of the packet engines is shared amongst multiple services performed by the at least one packet engine;
the configuration rules specifying a value that defines a ratio of packets processed by the multiple services to route data packets according to the ratio amongst the multiple services executed by the packet engine.

22. The switch of claim 21 further comprising:
a scheduling service that distributes packets to the multiple parallel services according to the value specified by the static configuration rules.
